(19) United States
(12) Patent Application Publication
(10) Pub. No.: US 2021/0203270 A1
(43) Pub. Date: Jul. 1, 2021

(54) MODULAR SUPPORT FRAME FOR SOLAR POWER ASSEMBLY

(71) Applicant: JING-XIN SOLAR LTD., Tainan City (TW)

(72) Inventor: Ching-Lung YANG, TAINAN CITY (TW)

(21) Appl. No.: 16/773,324

(22) Filed: Jan. 27, 2020

(30) Foreign Application Priority Data
Dec. 27, 2019 (TW) 108148155

(51) Int. Cl. H02S 20/20

(52) U.S. Cl. CPC H02S 20/20

(57) ABSTRACT

A modular support frame for solar power assembly, includes a fixing part having a first end and a second end, and a coupling part having a guide groove extending between the first end and second end of the fixing part. An included angle is formed between the extending direction of the guide groove and the vertical direction so that a solar power assembly can be set between the first end and second end of the fixing part along the guide groove of the coupling part to achieve the invention object of convenient and fast assembly of a solar power assembly.

### BACKGROUND OF THE INVENTION

### 1. Field of the Invention

The present invention relates to solar power technology and more particularly, to a modular support frame for solar power assembly.

### 2. Description of the Related Art

Solar power modules are usually set on the roof of a building, or on an open and uncovered land, so that sunlight can be maximally radiated to the installed solar power modules. In this way, it can generate economically valuable power, and at the same time can achieve the purpose of protecting the environment in line with environmental protection and green energy.

Generally, before setting up a solar power module, you must first use a number of steel combinations to form a scaffolding structure, and then tile all the solar power modules together, and then add a fixing method sufficiently to make the overall structure strong enough under various weather conditions without being damaged.

However, the above-mentioned related components for the scaffolding structure are many and complex, and the installation is very difficult, time-consuming and difficult to apply, and the overall cost is relatively expensive.

### SUMMARY OF THE INVENTION

The present invention has been accomplished under the circumstances in view. It is the main object of the present invention to provide a modular support frame for solar power assembly, which facilitates convenient and quick installation of solar power assemblies.

To achieve this and other objects of the present invention, a modular support frame for solar power assembly comprises a fixing part and a coupling part. The fixing part comprises a first end and a second end. The coupling part comprises a guide groove extending between the first end and second end of the fixing part. The extending direction of the guide groove defines with the vertical direction an included angle therebetween so that a solar power assembly can be between the first end and second end of the fixing part along the guide groove of the coupling part to achieve the invention object of convenient and fast assembly of a solar power assembly.

Preferably, the fixing part comprises an upright portion and a plurality of positioning portions located on a bottom side of the upright portion.

Preferably, the positioning portions protrude outward from two opposite sides of a bottom edge of the upright portion in a staggered manner.

Preferably, the fixing part comprises an upright portion. The upright portion comprises an inclined top edge. The first end and second end of the fixing part are respectively located at two ends of the top edge of the upright portion and inclined correspondingly.

Preferably, the coupling part comprises a plurality of projections and at least one elongated guide rail. The projections are arranged on the fixing part and spaced and staggered to protrude outwards on two opposite sides of the fixing part. The at least one guide rail is arranged on the fixing part to form the said guide groove. The extending direction of the guide groove defines with the horizontal direction an included angle therebetween.

Preferably, the fixing part comprises an upright portion, and one guide rail is arranged on each of two opposite sides of the upright portion of the fixing part.

Preferably, the fixing part further comprises a sloping plate extending to the ground.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top devotional view of a modular support frame for solar power assembly in accordance with a preferred embodiment of the present invention.

FIG. 2 is an applied view of the preferred embodiment of the present invention (I).

FIG. 3 is an applied view of the preferred embodiment of the present invention (II).

FIG. 4 is a schematic sectional view of a part of the modular support frame for solar power assembly in accordance with the preferred embodiment of the present invention.

FIG. 5 is a front view of the preferred embodiment of the present invention where the sloping plate is not shown.

FIG. 6 is a rear view of the preferred embodiment of the present invention Where the sloping plate is not shown.

FIG. 7 illustrates an alternate form of the modular support frame for solar power assembly in accordance with the present invention.

FIG. 8 is an applied view of the modular support frame shown in FIG. 7.

### DETAILED DESCRIPTION OF THE INVENTION

The technical contents and features of the present invention will now be described hereinafter with reference to the accompanying drawings. Those skilled in the art can understand that the description terms of the preferred embodiment belong to a higher-level description that does not limit the application field of solar power generation modules, for example, the term material or shape includes and is not limited to the material or shape specified in the description, the term location includes but is not limited to setting, approaching, connecting, or adjoining, and the number “a” of each component includes one and more than one component number. The directional adjectives such as “up”, “down”, “inside”, “outside”, “top”, and “bottom” mentioned in the contents of this specification are merely illustrative description terms based on the normal use direction, not as the purpose of limiting the scope of the claims.

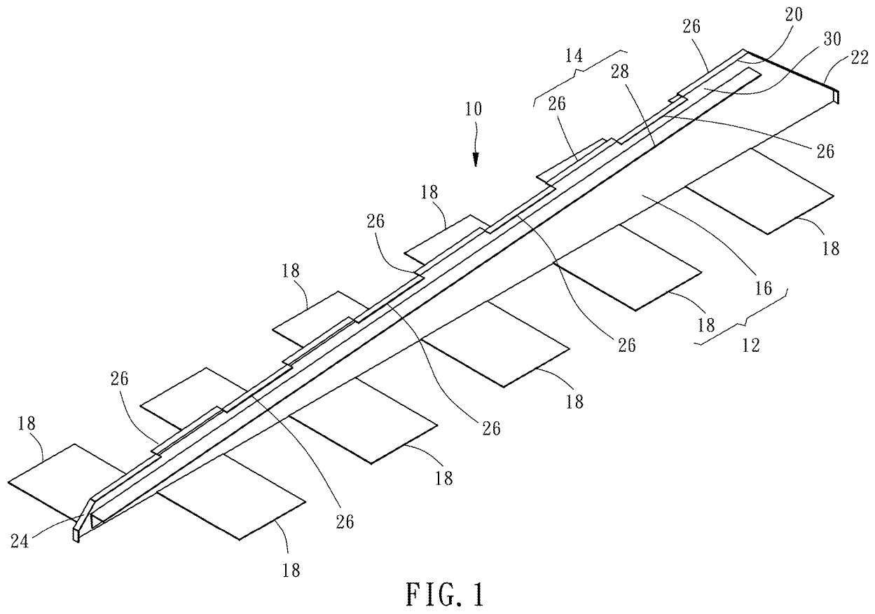

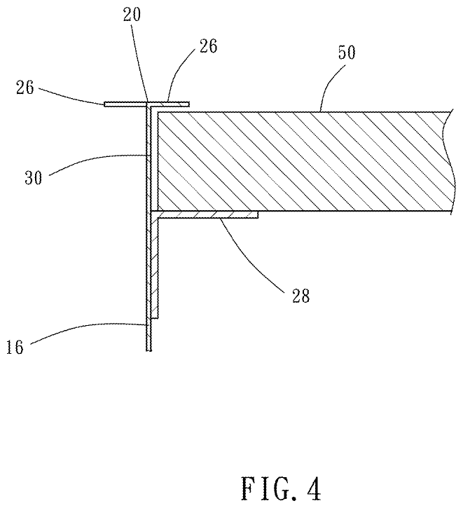

As shown in FIG. 1 to FIG. 4, a modular support frame 10 for a solar power assembly 50 provided by a preferred embodiment of the present invention is made of a metal plate as an example. The modular support frame 10 comprises a fixing part 12 and a coupling part 14. In the present preferred embodiment, the fixing part 12 comprises a long plate-shaped upright portion 16 and a plurality of positioning portions 18 located on the bottom side of the upright portion 16. The plurality of positioning portions 18 protrude outward from both sides of the bottom edge of the upright portion 16 in a staggered manner. The upright portion 16 in the present preferred embodiment has an inclined top edge 20, and a first end 22 and a second end 24 respectively located at two ends of the top edge 20. The first end 22 and the second end 24 are inclined correspondingly.

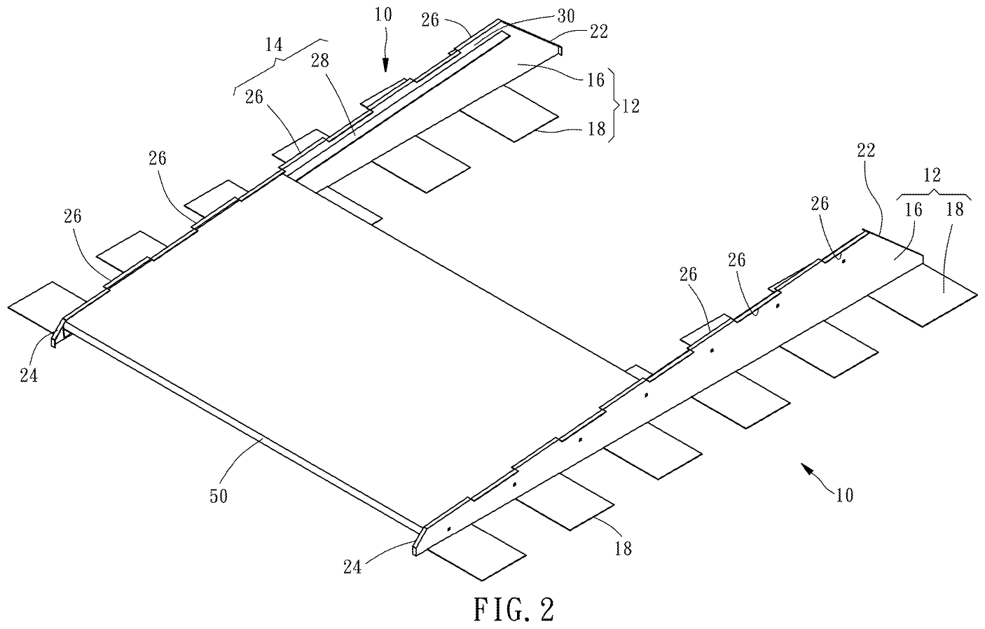

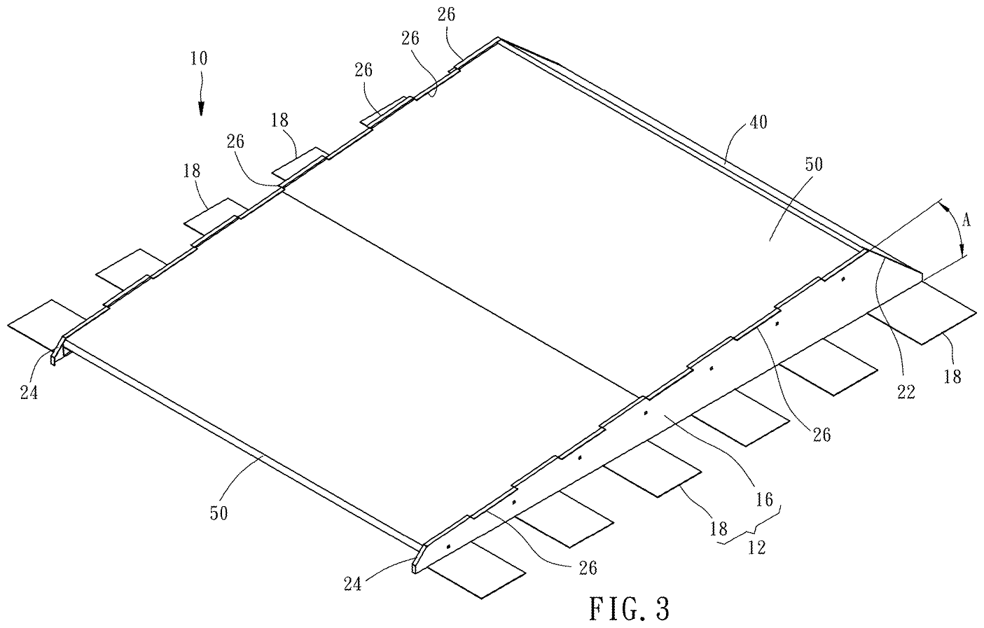

The coupling part 14 of the modular support frame 10 is set in the fixing part 12. Specifically, the coupling part 14 in the present preferred embodiment is located at the inclined top edge 20 adjacent to the upright portion 16. The coupling part 14 comprises a plurality of projections 26 and at least one elongated guide rail 28. The projections 26 are arranged along the inclined top edge 20 between the first end 22 and the second end 24. The projections 26 are spaced and staggered to protrude outwards on both sides of the upright portion 16. The at least one elongated guide rail 28 can optionally be extended on one or both sides of the upright portion 16. In this preferred embodiment, one guide rail 28 is taken as an example. The guide rail 28 extends approximately parallel to the inclined top edge 20 of the upright portion 16, thereby forming a guide groove 30 extending between the first end 22 and the second end 24. There is an included angle A between the extending direction of the guide groove 30 and the vertical direction. As shown in FIGS. 2 and 3, when two modular support frames 10 are arranged symmetrical to each other, the two outer sides of the solar power assembly 50 can be located between the first end 22 and the second end 24 along the guide groove 30 of the coupling part 14.

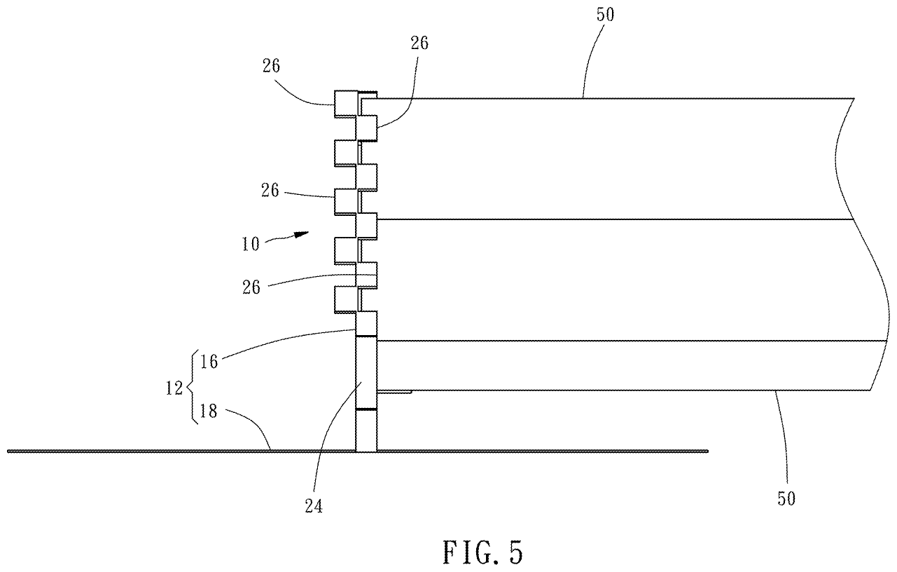

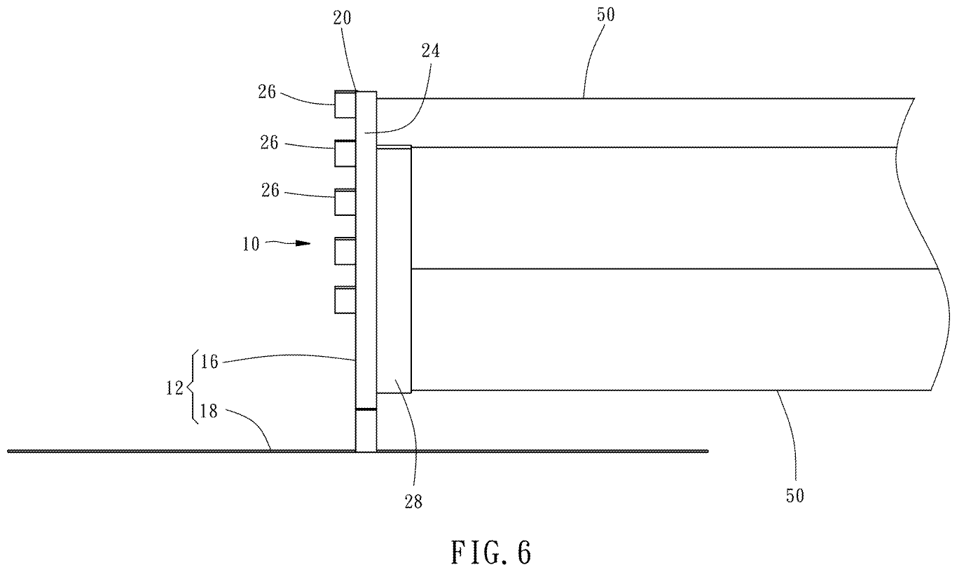

With the above components, as shown in FIGS. 2-6, when you want to set the solar power assembly 50, you only need to arrange more than 2 modular support frames 10 on the ground directly, and then use heavy objects or building materials such as concrete and the like to fix the fixing part 12 to the ground, and then insert the solar power assemblies 50 diagonally along each guide groove 30 from the first end 22 of each fixing part 12 to complete the assembly of the solar power assembly 50. In this preferred embodiment, two solar power assemblies 50 are arranged between two modular support frames 10 as an example. By the application of the present invention, a solar power assembly 50 can be quickly fixed to the ground without complicated parts and assembly operations, greatly saving installation time and operating procedures, and achieving the invention purpose of convenient and rapid assembly of solar power components.

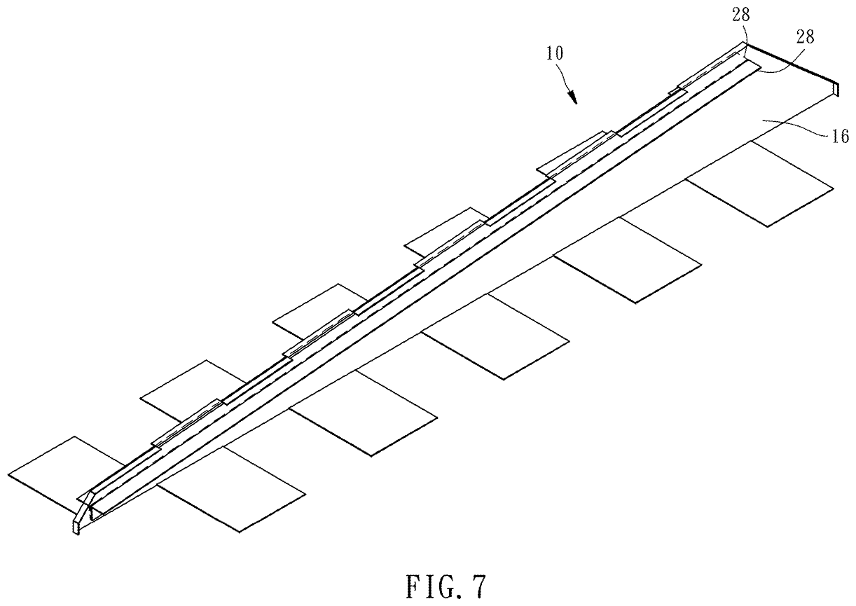

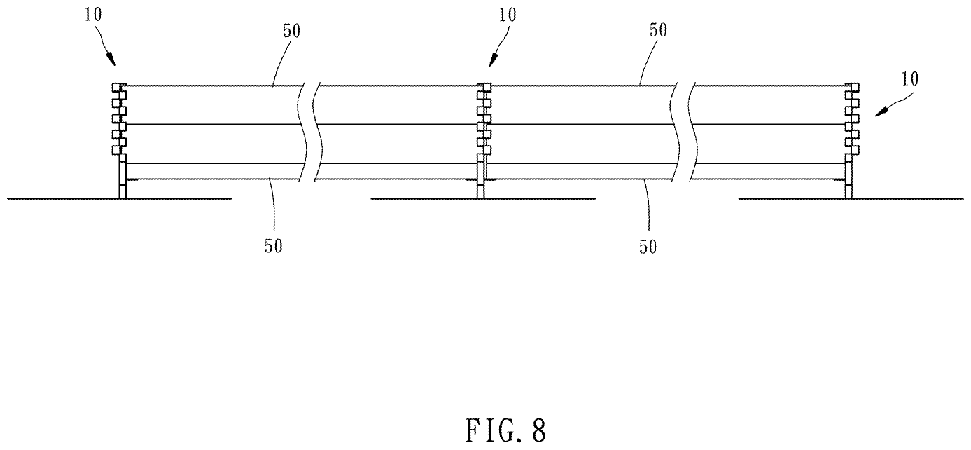

If you want to install multiple solar power assemblies 50 on a large area on the ground, as shown in FIGS. 7 and 8, guide rails 28 are set on both sides of the upright portion 16 of the modular support frame 10, so that multiple solar power assemblies 50 can be set on both sides of the modular support frame 10, keeping all the set solar power assemblies 50 to be continuously extended side by side on the ground or the roof of a building. Furthermore, as shown in FIG. 3, the first end 22 of the fixing part 12 may be provided with a sloping plate 40 extending to the ground for wind blocking and guiding the wind current, which can increase the effect of the wind pressure resistance.

What is claimed is:

1. A modular support frame for solar power assembly, comprising a fixing part and a coupling part, said fixing part comprising a first end and a second end, said coupling part comprising a guide groove extending between said first end and said second end, the extending direction of said guide groove defining with the vertical direction an included angle therebetween so that a solar power assembly is settable between said first end and said second end of said fixing part along said guide groove of said coupling part.

2. The modular support frame for solar power assembly as claimed in claim 1, wherein said fixing part comprises an upright portion and a plurality of positioning portions located on a bottom side of said upright portion.

3. The modular support frame for solar power assembly as claimed in claim 2, wherein said positioning portions protrude outward from two opposite sides of a bottom edge of said upright portion in a staggered manner.

4. The modular support frame for solar power assembly as claimed in claim 1, wherein said fixing part comprises an upright portion, said upright portion comprises an inclined top edge, and the said first end and the said second end are respectively located at two ends of said top edge and inclined correspondingly.

5. The modular support frame for solar power assembly as claimed in claim 1, wherein said coupling part comprises a plurality of projections and at least one elongated guide rail, said projections being arranged on said fixing part and spaced and staggered to protrude outwards on two opposite sides of said fixing part, said at least one guide rail being arranged on said fixing part to form said guide groove, the extending direction of said guide groove defining with the horizontal direction an included angle therebetween.

6. The modular support frame for solar power assembly as claimed in claim 5, wherein said fixing part comprises an upright portion; said coupling part comprises a plurality of said guide rails respectively arranged on two opposite sides of said upright portion of said fixing part.

7. The modular support frame for solar power assembly as claimed in claim 1, wherein said fixing part further comprises a sloping plate extending to the ground.
